(19) United States
(12) Patent Application Publication
(10) Pub. No.: US 2016/0214252 A1
(43) Pub. Date: Jul. 28, 2016

(54) TOOL BOX WITH PIVOTAL BIT CARRIER

(71) Applicant: Shao-Hsien Hsu, Taichung City (TW)

(72) Inventor: Shao-Hsien Hsu, Taichung City (TW)

(21) Appl. No.: 14/606,024

(22) Filed: Jan. 27, 2015

(51) Int. Cl. B25H 3/00

(52) U.S. Cl. CPC B25H 3/003

(57) ABSTRACT

A tool box includes a U-shaped body having a first pivotal portion and a second pivotal portion. A carrier is located in the installation opening and pivotably connected between the first and second pivotal portions by engaging two pivots of the carrier with the reception holes in the first and second pivotal portions. The carrier has multiple recesses for receiving bits therein. Multiple magnets are connected to one end of the carrier so as to be attached on a metal surface. The cannier is angularly positioned relative to the body when the carrier is pivoted an angle so that the user can easily pick the bits. The cannier is positioned relative to the body when the carrier is pivoted to be received in the installation opening.

### BACKGROUND OF THE INVENTION

1. Fields of the Invention

The present invention relates to a tool box, and more particularly, to a tool box with a carrier which is pivotably connected to the body of the tool box so as to be pivoted for convenience of picking bits from the carrier.

2. Descriptions of Related Art

There are many different types and sizes of bits in the market and a hand tool can be cooperated with these bits to deal with different types and sizes of bolts and objects. These bits are small and easily to carry, however, the bits are also easily to drop. Generally, the user has a tool box to receive the hand tool and the bits, the bits are randomly received in the tool box so that the user has to spend time to find the one he/she needs from the randomly put bits. The conventional tool boxes are bulky and heavy. Some have organized racks for organize the bits, but these racks are cooperated with complicated structure which may not be suitable for most of the users. Besides, the big tool box cannot be put beside the working area if there is limited room available.

The present invention intends to provide a tool box to eliminate the shortcomings mentioned above.

### SUMMARY OF THE INVENTION

The present invention relates to a tool box and comprises a U-shaped body having a first pivotal portion and a second pivotal portion. An installation opening is defined between the first and second pivotal portions. The first and second pivotal portions each have a reception hole defined in the inside thereof. A carrier is located in the installation opening and pivotably connected between the first and second pivotal portions. The carrier has a first end and a second end, and multiple recesses defined in the first end of the carrier so as to receive bits therein. Each recess has a resilient plate connected to the inside thereof so as to bias the bit in the recess. Multiple magnets are connected to the second end of the carrier so as to attach the carrier on a metal surface. The carrier has a first side and a second side, wherein a pivot extends from each of the first and second sides of the carrier. The two pivots are pivotably engaged with the reception holes in the first and second pivotal portions.

Preferably, two ribs extend radially outward from one of the pivots. One of the first and second pivotal portions has two grooves defined in the inside thereof. The two grooves communicate with the reception hole. The two ribs are engaged with the two grooves when the carrier is pivoted to be received in the installation opening.

Preferably, two protrusions are located beside the other one of the pivots. The other one of the first and second pivotal portions has two notches defined in the inside thereof. The two protrusions are engaged with the two notches when the carrier is pivoted to be tilt relative to the body.

Preferably, the body has a power portion which is connected between the first and second pivotal portions. A light is connected to the first pivotal portion and electrically connected to the power portion. A switch is electrically connected to one end of the power portion to control the light.

Preferably, the power portion has a space in which a power source is received, wherein the power source is batteries.

Preferably, the carrier has a room defined therein which opens through two opposite surfaces and one of the first and second sides of the carrier. The room receives an extension bar therein.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a perspective view to show the tool box of the present invention;

FIG. 2 is an exploded view of the tool box of the present invention;

FIG. 3 is another exploded view of the tool box of the present invention;

FIG. 4 shows that the carrier is pivoted relative to the body of the tool box of the present invention;

FIG. 5 shows that the carrier is attached to a metal surface to position the tool box of the present invention;

FIG. 6 is a cross sectional view to show the connection between the carrier and the body, wherein the carrier is not yet pivoted;

FIG. 7 is a cross sectional view to show the connection between the carrier and the body, wherein the carrier is pivoted relative to the body, and

FIG. 8 shows the operation of the light of the tool box of the present invention.

### DETAILED DESCRIPTION OF THE PREFERRED EMBODIMENT

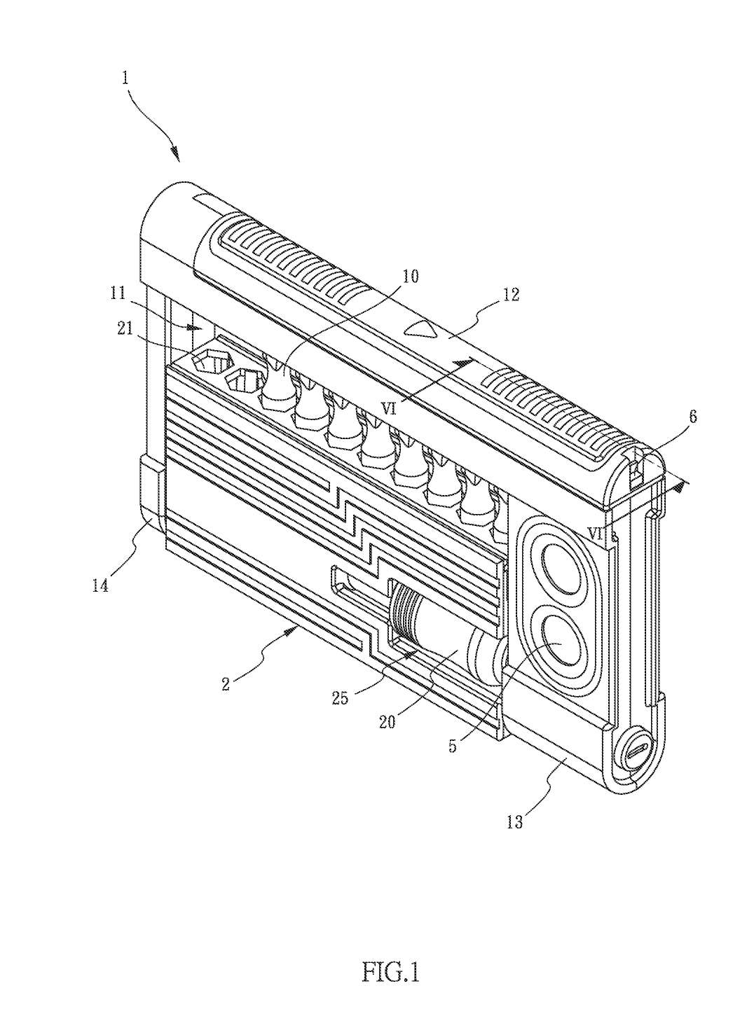

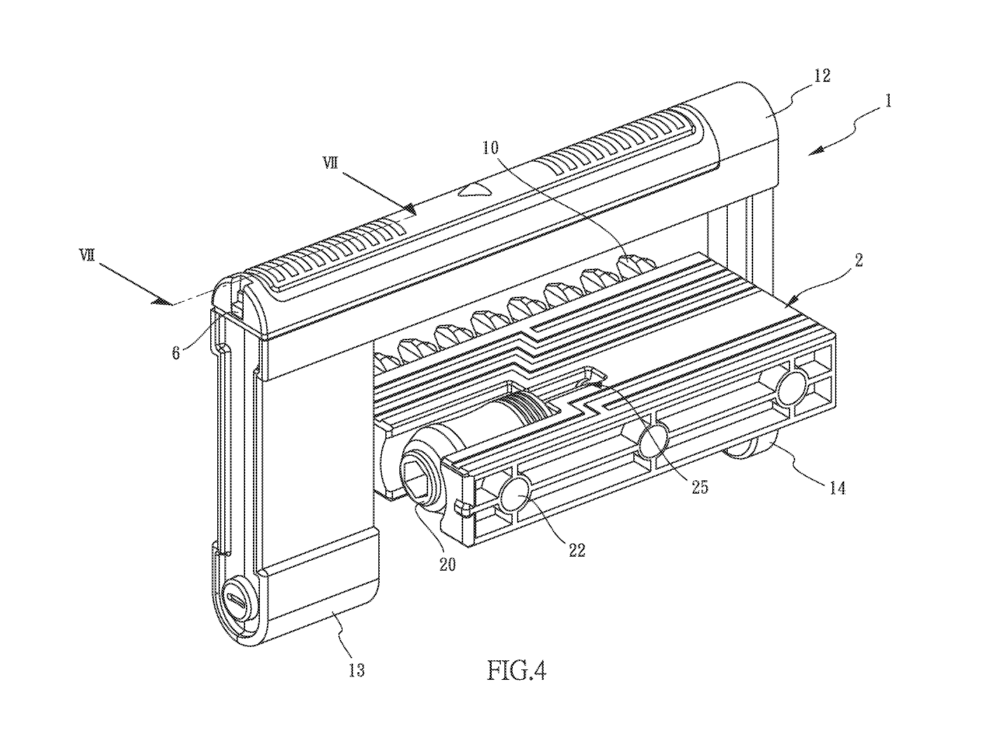

Referring to FIGS. 1 to 4, the tool box of the present invention comprises a U-shaped body 1 having a power portion 12 which is connected between a first portion 13 and a second pivotal portion 14. An installation opening 11 is defined between the power portion 12 and the first and second pivotal portions 13, 14. The first and second pivotal portions 13, 14 each have a reception hole 24 defined in the inside thereof.

A carrier 2 is located in the installation opening 11 and pivotably connected between the first and second pivotal portions 13, 14. The carrier 2 has a first end and a second end, and multiple hexagonal recesses 21 are defined in the first end of the carrier 2 so as to receive bits 10 therein. Each recess 21 has a resilient plate 211 connected to the inside thereof so as to bias and position the bit 10 in the recess 21. Multiple magnets 22 connected to the second end of the carrier 2 so as to attach the carrier 2 on a metal surface. The carrier 2 further has a first side and a second side. A pivot 23 extends from each of the first and second sides of the carrier 2. The two pivots 23 are pivotably engaged with the reception holes 24 in the first and second pivotal portions 13, 14 so that the carrier 2 is pivotable relative to the body 1.

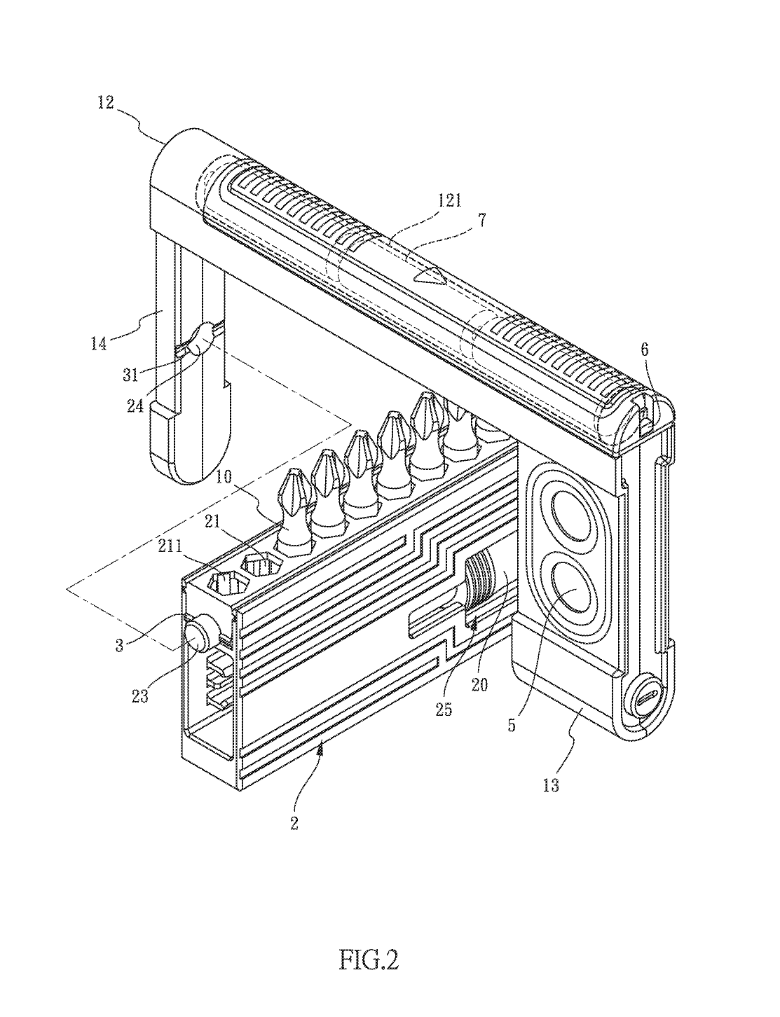

There are two ribs 3 extend radially outward from one of the pivots 23 as shown in FIG. 2. The second pivotal portion 14 has two grooves 31 defined in the inside thereof, the two grooves 31 communicate with the reception hole 24. The two ribs 3 are engaged with the two grooves 31 when the carrier 2 is pivoted to be received in the installation opening 11.

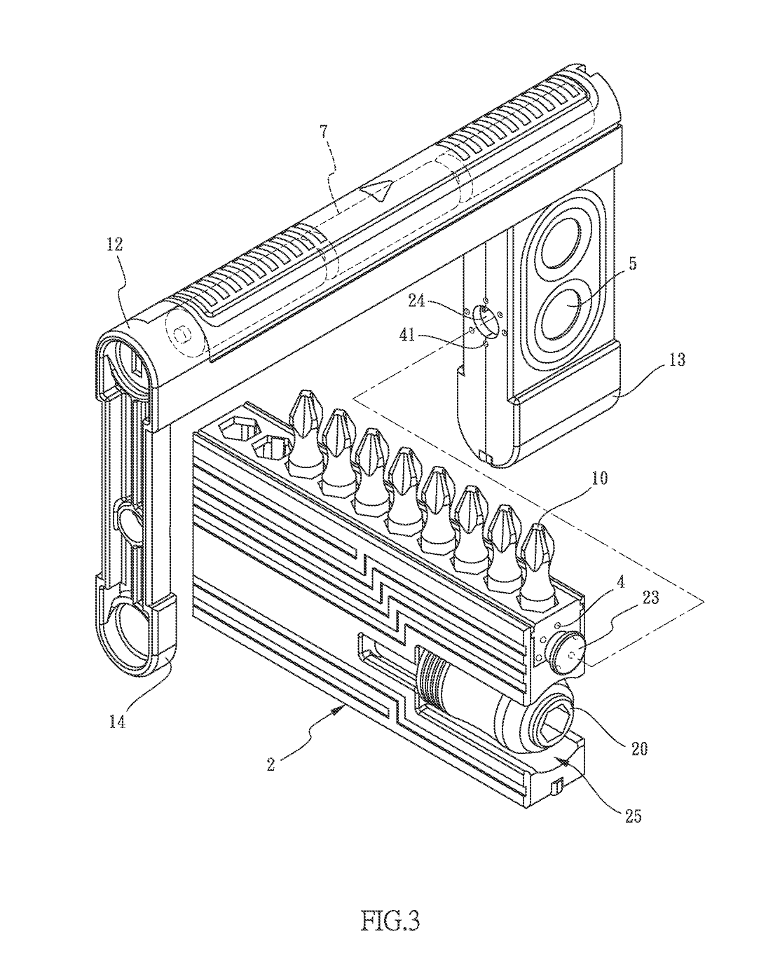

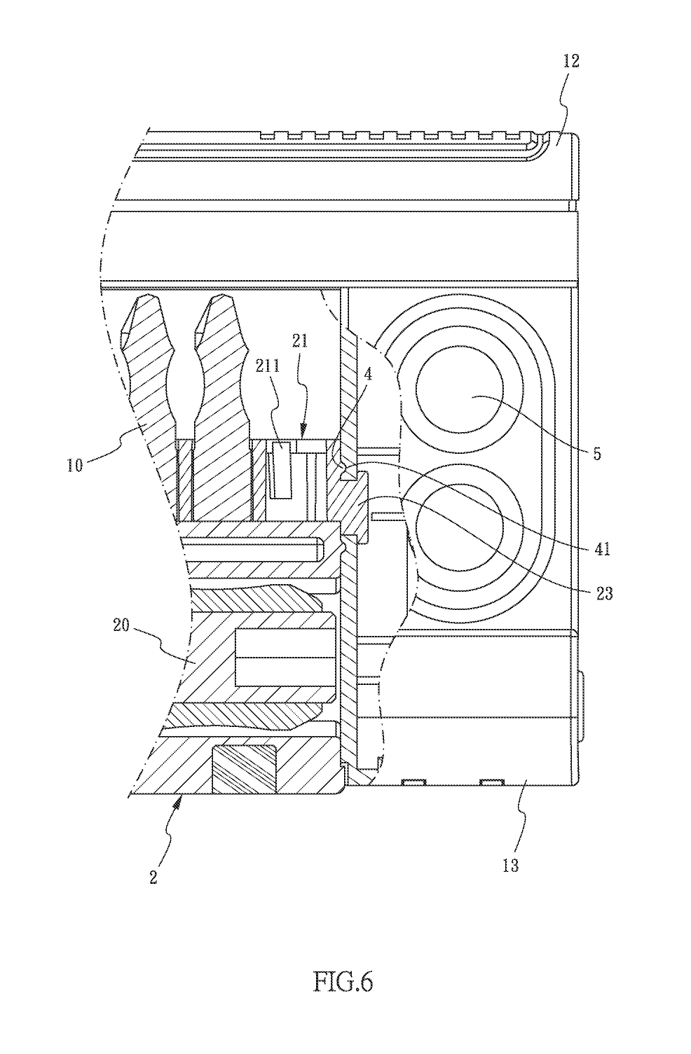

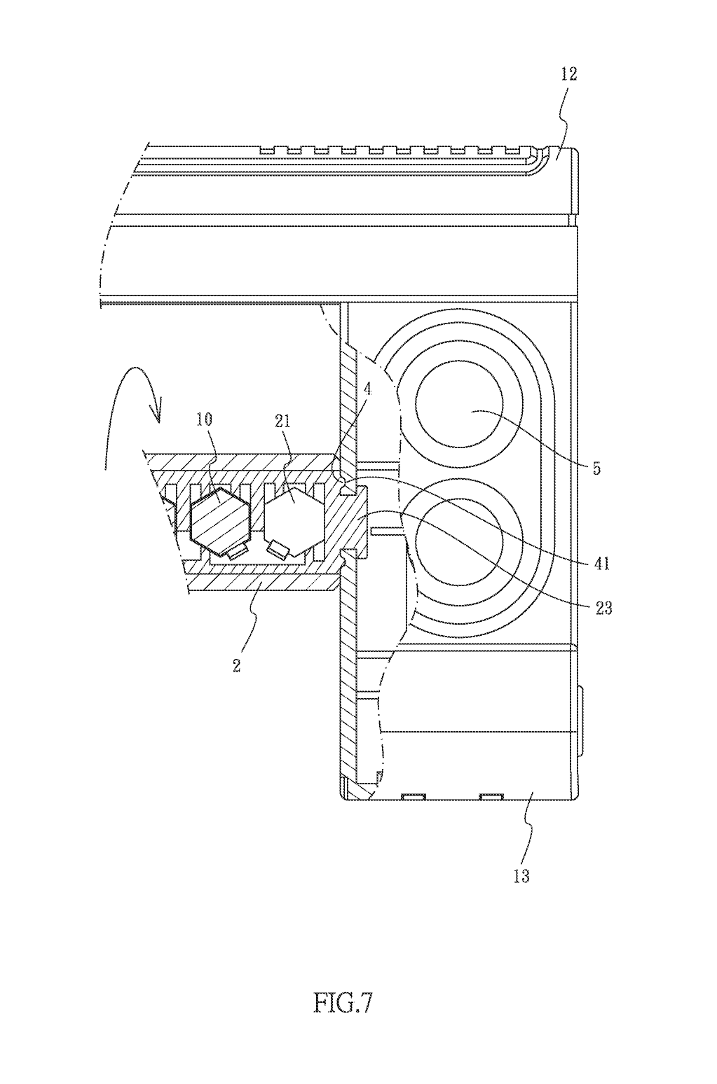

As shown in FIG. 3, there are multiple protrusions 4 located beside the other one of the pivots 23, and the first pivotal portion 13 has multiple notches 41 defined in the inside thereof. The protrusions 3 are engaged with the notches 41 when the carrier 2 is pivoted to be tilt relative to the body 1. By the engagement between the protrusions 3 are engaged with the notches 41 as shown in FIGS. 6 and 7, the carrier 2 can be positioned at desired angular position relative to the body 1 so that the user can easily and conveniently pick the desired bits 10 from the carrier 2.

The carrier 2 further has a room 25 defined therein which opens through two opposite surfaces and one of the first and second sides of the carrier 2. The room 25 is used to receive an extension bar 20 therein.

Two lights 5 are connected to the first pivotal portion 13 and electrically connected to the power portion 12. The power portion 12 has a space 121 in which a power source 7 is received, the power source 7 can be batteries such as Lithium batteries or any know batteries. A switch 6 is electrically connected to one end of the power portion 12 to control the lights 5.

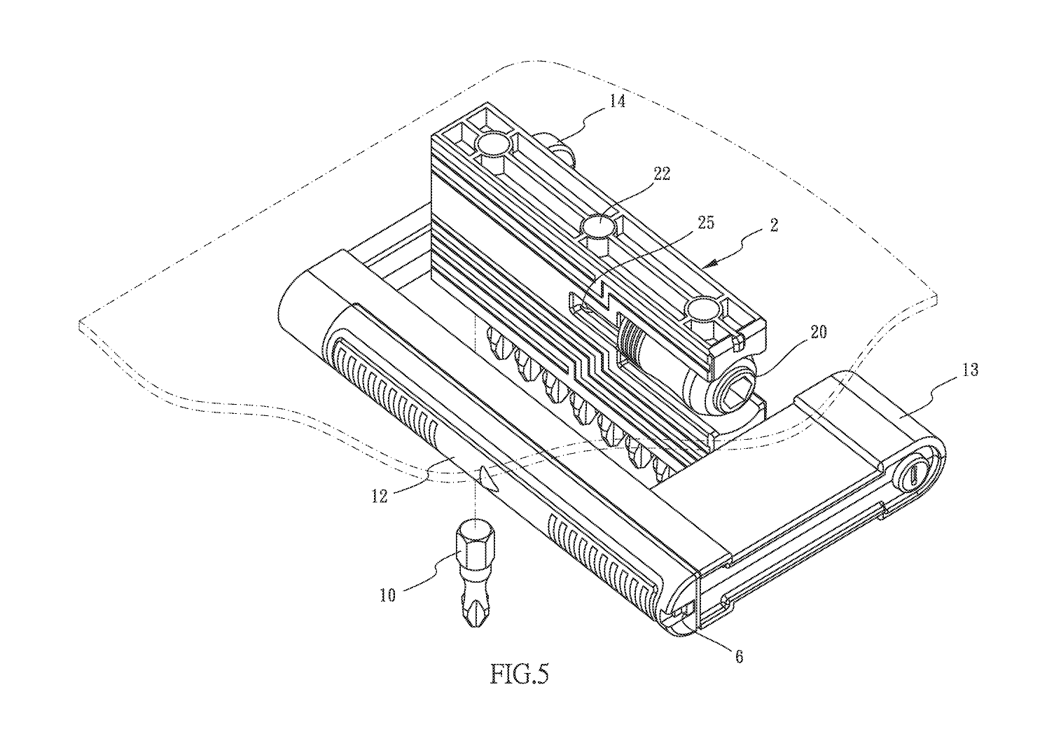

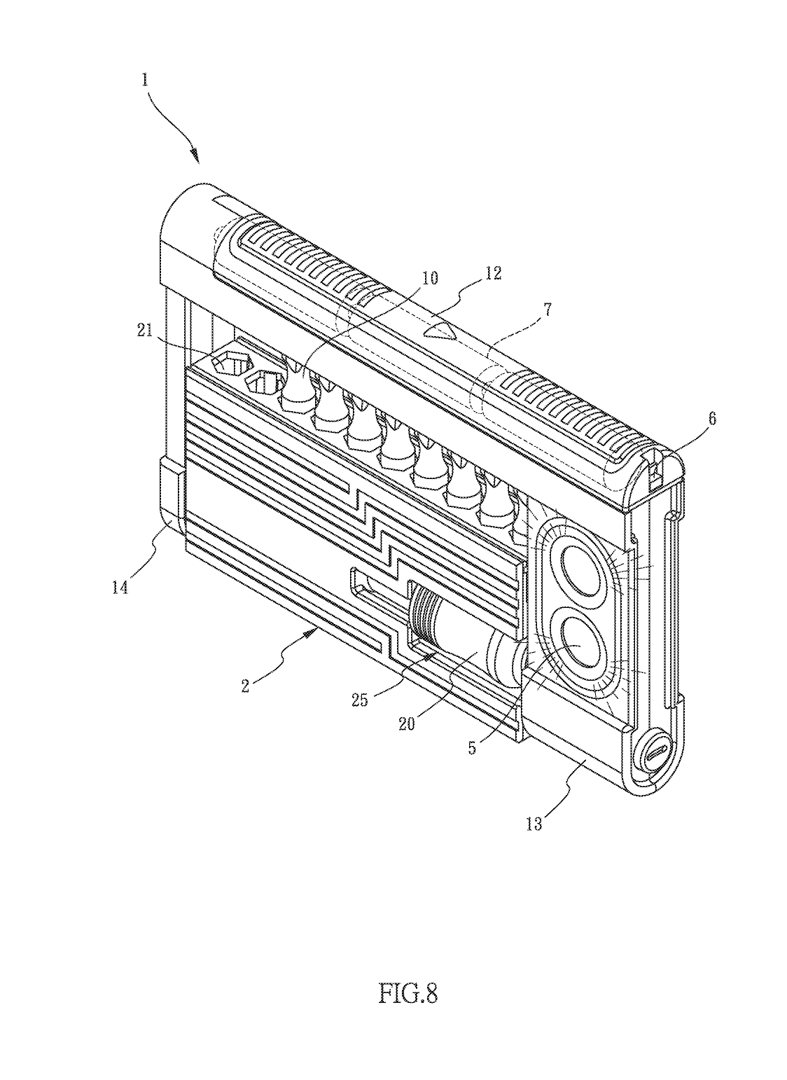

When in use, the carrier 2 is pivoted to a desired angular position and the carrier 2 is positioned by the engagement between the protrusions 3 are engaged with the notches 41. The user then picks the desired bit 10 from the carrier 2. When needed, the magnets 22 are used to magnetically attach the carrier 2 to a metal surface such as shown in FIG. 5. As shown in FIG. 8, the lights 5 are turned on by switching the switch 6 so illuminate the place where the bolts or objects are located.

The carrier 2 allows the bits 10 and the extension bar 20 to be well stored so that they do not drop. The combination of the body 1 and the carrier 2 is compact, so that the users can easily carry. The carrier 2 can be magnetically attached to a metal surface and the bits 10 do not drop from the recesses 21 because of the resilient plates 211 in the recesses 21. The lights 5 allow the user to work in a dark area. The present invention meets different requirements from users.

While we have shown and described the embodiment in accordance with the present invention, it should he clear to those skilled in the art that further embodiments may be made without departing from the scope of the present invention.

What is claimed is:

1. A tool box comprising:
a U-shaped body (1) having a first pivotal portion (13) and a second pivotal portion (14), an installation opening (11) defined between the first and second pivotal portions (13, 14), the first and second pivotal portions (13, 14) each having a reception hole (24) defined in an inside thereof, and
a carrier (2) located in the installation opening (11) and pivotably connected between the first and second pivotal portions (13, 14), the carrier (2) having a first end and a second end, multiple recesses (21) defined in the first end of the carrier (2) so as to be adapted to receive bits (10) therein, each recess (21) having a resilient plate (211) connected to an inside thereof so as to be adapted to bias the bit (10) in the recess (21), multiple magnets (22) connected to the second end of the carrier (2) so as to be adapted to attach the carrier (2) on a metal surface, the carrier (2) having a first side and a second side, a pivot (23) extending from each of the first and second sides of the carrier (2), the two pivots (23) being pivotably engaged with the reception holes (24) in the first and second pivotal portions (13, 14).

2. The tool box as claimed in claim 1, wherein two ribs (3) extend radially outward from one of the pivots (23), one of the first and second pivotal portions (13, 14) has two grooves (31) defined in the inside thereof, the two grooves (31) communicate with the reception hole (24), the two ribs (3) are engaged with the two grooves (31) when the carrier (2) is pivoted to be received in the installation opening (11).

3. The tool box as claimed in claim 2, wherein two protrusions (4) are located beside the other one of the pivots (23), the other one of the first and second pivotal portions (13, 14) has two notches (41) defined in the inside thereof, the two protrusions (3) are engaged with the two notches (41) when the carrier (2) is pivoted to be tilt relative to the body (1).

4. The tool box as claimed in claim 1, wherein the body (1) has a power portion (12) which is connected between the first and second pivotal portions (13, 14), a light (5) is connected to the first pivotal portion (13) and electrically connected to the power portion (12), a switch (6) is electrically connected to one end of the power portion (12) to control the light (5).

5. The tool box as claimed in claim 4, wherein the power portion (12) has a space (121) in which a power source (7) is received, the power source (7) is batteries.

6. The tool box as claimed in claim 1, wherein the carrier (2) has a room (25) defined therein which opens through two opposite surfaces and one of the first and second sides of the carrier (2), the room (25) is adapted to receive an extension bar (20) therein.
